(19) United States
(12) Patent Application Publication
(10) Pub. No.: US 2021/0214272 A1
(43) Pub. Date: Jul. 15, 2021

(54) ADSORBING APPARATUS FOR GLASS WAFER

(71) Applicant: AAC Optics Solutions Pte. Ltd., Singapore city (SG)

(72) Inventors: Jacob Kibsgaard Kjær, Soborg (DK); Peter Krohne Nielsen, Hillerod (DK); Simon Bo Jensen, Hillerod (DK); Michal Sobol, Kobenhavn (PL); Tsz Lok Keith Tang, Hong Kong (CN); Thomas Aabo, Albertslund (DK); Niels Christian Roemer Holme, Farum (DK); Bingke Zhu, Shenzhen (CN)

(21) Appl. No.: 16/809,586

(22) Filed: Mar. 5, 2020

(30) Foreign Application Priority Data
Jan. 9, 2020 (CN) 202020048635.X

(51) Int. Cl. C03C 17/00

(52) U.S. Cl. CPC C03C 17/002

(57) ABSTRACT

An adsorbing apparatus for a glass wafer includes an adsorbing head and a block structure mounted to the adsorbing head. The adsorbing head defines a cavity and an opening directly touching a glass wafer. The block structure defines a channel connected with the cavity. A plurality of supporting posts for supporting the glass wafer are densely arranged in the cavity. The adsorbing apparatus as a transfer tool for a glass wafer, which can transport unmolded wafer to the mold for molding, and can remove the glass wafer before fully executing cool down, thereby avoiding many adverse effects in the glass wafer forming process and shortening production time and improving production efficiency.

### TECHNICAL FIELD

The disclosure relates to the field of glass wafer manufacturing process, and in particular to an adsorbing apparatus for a glass wafer.

### BACKGROUND

In a wafer-level molding process, a glass wafer is formed at high temperature above glass transition temperature. A subsequently molded product will, simply because of gravity, cool down while resting on the lower part of the mold.

Due to broad temperature ranges of the process, high molding forces and the use of materials with different thermal expansion coefficient multiple undesirable effects can occur during cool down that can detriment the final quality of the product.

Specifically, there are the following adverse effects:

Firstly, Thermal Uniformity: During the final steps of molding process, a wafer-level may have spot-wise or one-sided contact with the mold surface, which will cause non-uniform thermal distribution and asymmetrical shrinking of the glass, which way will lead to distortion of the final product in an uncontrolled way.

Secondly, Surface Adhesion: During the molding process, the product undergoes strong adhesion to the surface of the mold. During cool down this effect is reduced, but allowing the product to cool down fully and self-release is costly in terms of cycle time. In some cases, when the adhesion is too strong, so that the product will break.

Thirdly, Thermal Expansion: Lens designs with tall, larger angle features pose a risk of breaking the glass wafer during the wafer shrinkage since glass shrinks more than the mold during cool down and the lens design feature in the mold will prohibit the glass from shrinking freely in the horizontal direction. This is particularly problematic for large diameter wafers where an expansion coefficient difference between materials is more profound.

Fourthly, Cycle Time: The cool down process is a relatively long part of the molding process and by removing the product sooner will allow us to reduce production time.

### SUMMARY

In order to overcome the deficiencies of the prior art, the disclosure provides an adsorbing apparatus for a glass wafer.

The objective of the disclosure is achieved by the following technical solutions:

An adsorbing apparatus for a glass wafer includes an adsorbing head defining a cavity and an opening directly touching a glass wafer, and a block structure mounted to the adsorbing head; wherein the block structure defines a channel connected with the cavity; and a plurality of supporting posts for supporting the glass wafer; the plurality of supporting posts are densely arranged in the cavity.

Preferably, the adsorbing head is circular and the opening is circular.

Preferably, a diameter of the adsorbing head is greater than that of the glass wafer, a diameter of the opening is less than that of the glass wafer, the adsorbing head is configured to completely cover the glass wafer, and the glass wafer configured to completely cover the opening.

Preferably, each supporting post is square and the plurality of supporting posts are equably arranged in the cavity.

Preferably, each supporting post extends from a bottom of the cavity to the opening and is configured to align with the opening.

Preferably, the adsorbing apparatus is made of low thermal conductivity and low expansion coefficient materials.

In the disclosure, the adsorbing apparatus as a transfer tool for a glass wafer, which can transport unmolded wafer to the mold for molding, and can remove the glass wafer before fully cool down. In this way, the contact between the glass wafer and the mold surface during the cooling process can be greatly reduced, and the glass wafer loses heat mostly through radiation. In this way, the glass wafer can be cooled down in a uniform and controlled manner.

Furthermore, since the glass wafer and mold are separated any features that are present at the mold won't be able to stop the natural shrinkage of the glass wafer which could otherwise crack the product and the shrinkage of the glass wafer which could otherwise crack the product.

And at the same time, separates the glass wafer from the mold before the glass wafer 5 fully cool down, thus the mold can mold the next blank glass wafer, which can greatly increase production efficiency and shorten the cycle time during production.

In the disclosure, the adsorbing apparatus utilizes a small pressure-difference between a pressure p1 formed by a vacuum pump in the low-pressure chamber and a pressure p2 formed by an additional vacuum pump in the cavity to lift the product.

What's more, the adsorbing apparatus is made of low thermal conductivity and low expansion coefficient materials to avoid the influence of the entire structure on the cooling of the glass wafer.

Lastly, in the disclosure, the adsorbing apparatus is capable to move horizontally and can be used as a transport tool for glass wafers.

### BRIEF DESCRIPTION OF THE DRAWINGS

FIG. 1 is a schematic structural view of an adsorbing apparatus for a glass wafer of the disclosure;

FIG. 2 is a top view of the adsorbing apparatus for the glass wafer of the disclosure;

FIG. 3 is a cross section taken along line A-A of FIG. 2;

FIG. 4 is a schematic view of horizontally moving a glass wafer at a position A and another position B by the adsorbing apparatus of the disclosure.

### DETAILED DESCRIPTION OF THE PREFERRED EMBODIMENTS

Below, embodiments of the disclosure will be described in detail with reference to the drawings. It should be noted that the Figures are illustrative rather than limiting. The Figures are not drawn to scale, only for illustrating every aspect of the described embodiments, and do not limit the scope of the present disclosure.

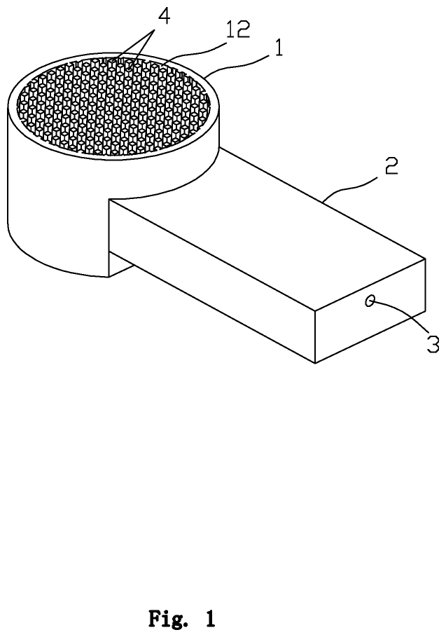

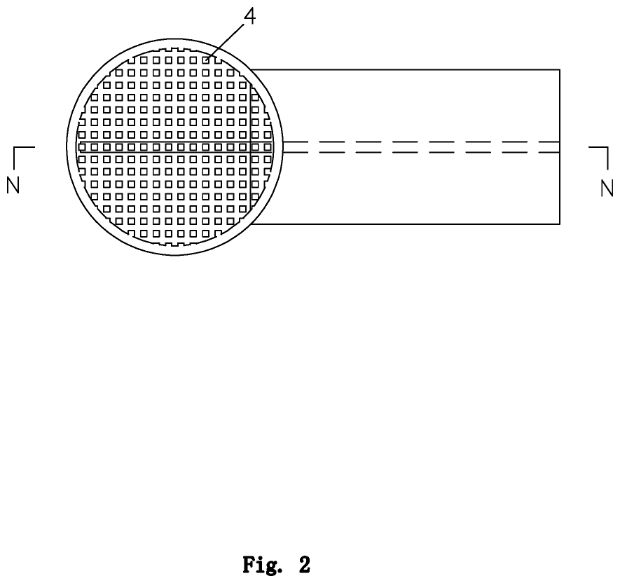

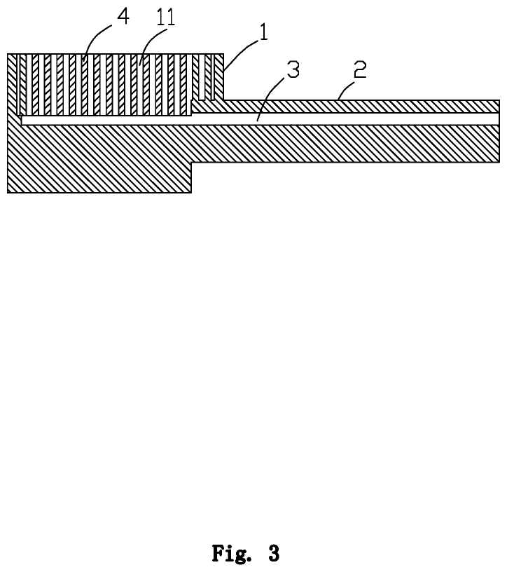

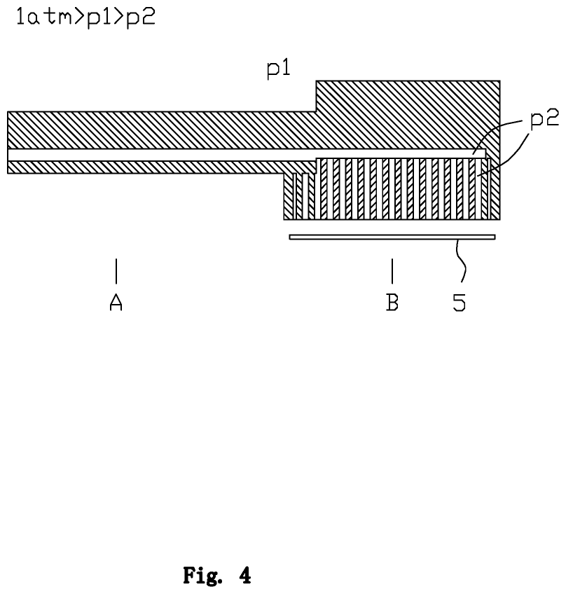

As shown in FIG. 1, an embodiment of the disclosure provides an adsorbing apparatus for a glass wafer including an adsorbing head 1 and a block structure 2 integrated with the adsorbing head 1. The adsorbing head 1 is circular, and the adsorbing head 1 defines a cavity 11 and a circular opening 12. In other embodiments, the adsorbing head 1 of other shapes may be used, which corresponds to opening 12 of other shapes, for example, square. As shown in FIG. 4, a diameter of the adsorbing head 1 is slightly greater than that of the glass wafer 5, and a diameter of the opening 12 is slightly less than that of the glass wafer 5, so that, the adsorbing head 1 can completely cover the glass wafer 5, and the glass wafer 5 can also completely cover the opening 12. As shown in FIG. 2, a plurality of supporting posts 4 are equably and densely arranged in the cavity 11. Furthermore, there is a gap between the supporting posts 4. In this embodiment, each supporting post is square and understandably, the supporting post may also be other shapes such as circular or triangular. The support of the supporting posts 4 to the glass wafer 5 can effectively prevent the glass wafer 5 from cracking when being adsorbed and allow for stronger adsorption. As shown in FIG. 3, each supporting post extends from a bottom of the cavity 11 to the opening 12 and is configured to align with the opening 12. The block structure 2 defining at least one channel 3 for building up vacuum internally.

The adsorbing apparatus and mold are configured in a low-pressure chamber with a pressure lower than the standard atmospheric pressure during the production process of a glass wafer 5. As shown in FIG. 4, the low-pressure chamber is pumped by a set of main pumps to make a pressure p1 in the low-pressure chamber lower than the standard atmospheric pressure. The adsorbing apparatus is mounted onto a servo driven arm and is located in a track system. The servo driven arm and track system are not shown in FIG. 4. The cavity 11 of the adsorbing apparatus is connected with an additional vacuum pump. When the adsorbing apparatus is needed, the additional vacuum pump is started so that a pressure p2 in the cavity 11 is lower than the pressure p1 in the low-pressure chamber, so that the adsorbing apparatus can suck the glass wafer 5 from the mold. In addition, while maintaining the pressure-difference between p2 and p1, the adsorbing apparatus can move the glass wafer 5 from a position A to another position B. After moving to the position B, the glass wafer 5 can be lowered by changing the pressure-difference between p2 and p1. Either the position A or the position B can be used as an indication of the mold position. When the position A is used as the mold position diagram, FIG. 4 shows that the adsorbing apparatus sucks the glass wafer 5 which is not completely cooled and formed from the mold. When the position B is used as the mold position diagram, FIG. 4 shows that the adsorbing apparatus carries the glass wafer 5 onto the mold before molding.

When the glass wafer 5 is formed, the glass wafer 5 being cooled on the mold is separated from the mold before the complete glass wafer 5 cool down to room temperature has finished or before the glass wafer 5 fully executing cool down, and then cooled to room temperature and finally formed. In this way, the contact between the glass wafer 5 and the mold surface during the cooling process can be greatly reduced. The adsorbing apparatus is made of low thermal conductivity and low expansion coefficient materials, such as machinable glass ceramic, advanced engineering ceramic, high performance alloy and so on. Heating element can also be added to the absorbing apparatus with low thermal conductivity to further improve the performance. The heating element is to actively heat up the pickup head to achieve no thermal conductivity from the wafer to the pickup head when the wafer is still on the mold. The heating element can be traditional heating coils, infrared heating elements, induction heating elements, etc. Therefore, after the glass wafer 5 is sucked from the mold by the adsorbing apparatus, the glass wafer 5 loses heat mostly through radiation. In this way the glass wafer 5 can be cooled down in a uniform and controlled manner. Furthermore since the glass wafer 5 and mold are separated any features that are present at the mold won't be able to stop the natural shrinkage of the glass wafer 5 which could otherwise crack the product, and the shrinkage of the glass wafer 5 which could otherwise crack the product. And at the same time, separates the glass wafer 5 from the mold before the glass wafer 5 fully cool down, thus the mold can mold the next blank glass wafer, which can greatly increase production efficiency and shorten the cycle time during production.

The above embodiments are only the preferred embodiments of the present invention, and do not limit the scope of the present invention. A person skilled in the art may make various other corresponding changes and deformations based on the described technical solutions and concepts. And all such changes and deformations shall also fall within the scope of the present invention.

1. An adsorbing apparatus for a glass wafer, comprising:
an adsorbing head defining:
a cavity, and
an opening directly touching a glass wafer; and
a block structure mounted to the adsorbing head;
wherein the block structure defines a channel connected with the cavity and a plurality of supporting posts for supporting the glass wafer; the plurality of supporting posts are densely arranged in the cavity.

2. The adsorbing apparatus of claim 1, wherein the adsorbing head is circular and the opening is circular.

3. The adsorbing apparatus of claim 2, wherein a diameter of the adsorbing head is greater than that of the glass wafer, a diameter of the opening is less than that of the glass wafer, the adsorbing head is configured to completely cover the glass wafer, and the glass wafer is configured to completely cover the opening.

4. The adsorbing apparatus of claim 1, wherein each supporting post is square and the plurality of supporting posts are equably arranged in the cavity.

5. The adsorbing apparatus of claim 1, wherein each supporting post extends from a bottom of the cavity to the opening and is configured to align with the opening.

6. The adsorbing apparatus of claim 1, wherein the adsorbing apparatus is made of low thermal conductivity and low expansion coefficient materials.
